(19) United States
(12) Patent Application Publication
(10) Pub. No.: US 2026/0259985 A1
(43) Pub. Date: Sep. 3, 2026

(54) Detection of Dynamic Link Library (DLL) Side Loading Attacks

(71) Applicant: Palo Alto Networks, Inc., Santa Clara, CA (US)

(72) Inventor: Chen Erlich, Beer Yaakov (IL)

(21) Appl. No.: 19/658,733

(22) Filed: Apr. 27, 2026

Related U.S. Application Data
(63) Continuation of application No. 18/789,787, filed on Jul. 31, 2024.

(51) Int. Cl. G06F 21/56

(52) U.S. Cl. CPC G06F 21/566; G06F 2221/034

(57) ABSTRACT

A method for detecting an attempt to side-load a malicious Dynamic Link Library (DLL) includes identifying a load image event in a computer system, the load image event indicating that an operating system has loaded an application together with a DLL. An event filtering criterion that assesses signatures of the application and the DLL is applied to the load image event. A profile filtering criterion that assesses prevalence of characteristics of the DLL within the computer system is applied to the load image event. Responsively to meeting both the event filtering criterion and the profile filtering criterion, a determination is made that the load image event is suspected of indicating a DLL side-loading attack.

### CROSS-REFERENCE TO RELATED APPLICATIONS

This application is a continuation of U.S. Application No. 18/789,787, filed July 31, 2024, which is hereby incorporated by reference in its entirety.

### FIELD OF THE INVENTION

The present invention relates generally to cyber security, and particularly to methods and systems for detecting DLL side loading attacks.

### BACKGROUND OF THE INVENTION

Operating systems such as Microsoft® Windows® and OS/2 make extensive use of Dynamic Link Libraries (DLLs). DLLs are files containing executable code and data that can be used by applications. To use a DLL, an application must first load it from storage to memory. In Windows, one option is for the application to specify the full path to the exact storage location of the DLL to be loaded. Applications are also permitted to refrain from specifying the full path to the DLL, in which case the operating system searches for the DLL in accordance with a predefined ordered list of locations.

The latter option opens the door to malicious attacks known as “DLL hijacking” and “DLL side loading”. In DLL hijacking, an application is lured to load a malicious DLL having the same file name as a benign DLL. To this end, the attacker stores the malicious DLL in a location that precedes the location of the benign DLL in the ordered list of locations searched by the operating system. In DLL side loading, the attacker typically also stores a version of the application that is prone to DLL hijacking, e.g., an application that omits the full path of the DLL in question.

### SUMMARY OF THE INVENTION

An embodiment of the present invention that is described herein provides a method for detecting a cyber-attack. The method includes identifying an event occurring in a computer belonging to a computer system, the event including loading of an application to memory together with a Dynamic Link Library (DLL). A filtering criterion is applied to the event, to verify that (i) the application and the DLL are loaded from the same folder, (ii) the application is signed and verified and (iii) the DLL does not have a valid signature. Responsively to meeting the filtering criterion, a profiling criterion is applied to the event, to verify that prevalences of defined characteristics of the DLL in the computer system are below defined prevalence levels. Responsively to meeting the profiling criterion, a decision is made that the DLL is suspected of being malicious.

In some embodiments, the method further includes initiating a responsive action upon deciding that the DLL is suspected.

In an embodiment, applying the profiling criterion includes verifying that the DLL was observed in the computer system (i) on less than a defined number of computers and (ii) during less than a defined number of days. In a disclosed embodiment, applying the profiling criterion includes verifying that a path to the DLL was observed, in the computer system, to contain DLLs having no valid signatures (i) on less than a defined number of computers and (ii) during less than a defined number of days.

In some embodiments, the method further includes evaluating a score of the event responsively to meeting the profiling criterion, and deciding whether the DLL is suspected of being malicious depending on the score. In an example embodiment, evaluating the score includes checking whether an entropy of the DLL is below a defined threshold. In another embodiment, evaluating the score includes checking whether an entropy of the DLL is above a defined threshold.

In yet another embodiment, evaluating the score includes checking whether the DLL was loaded from a folder defined as suspicious. In still another embodiment, evaluating the score includes checking whether the DLL was loaded from a folder having a single-character name. In another embodiment, evaluating the score includes checking whether the DLL is included in a defined list of DLLs known to be malicious. In yet another embodiment, evaluating the score includes checking whether the DLL was compiled with a different file name.

In still another embodiment, evaluating the score includes checking whether a command line of the application has no arguments. In an example embodiment, evaluating the score includes checking whether a time duration between creation and execution of the DLL is below a defined threshold. In a disclosed embodiment, evaluating the score includes checking whether the application is signed by a security company. In another embodiment, evaluating the score includes checking whether a time duration between creation and execution of the DLL is below a defined threshold.

In an embodiment, evaluating the score includes identifying, within the computer system, that (i) the application was observed loading the DLL as signed with a first prevalence that is above a first defined prevalence level; and (ii) the application was observed loading the DLL as unsigned with a second prevalence that is below a second defined prevalence level.

In an embodiment, evaluating the score includes identifying that (i) the application was observed loading the DLL as signed in more than a first defined number of computer systems; (ii) the application was observed loading the DLL as unsigned in less than a second defined number of computer systems; (iii) within the computer system, the application was observed loading the DLL as unsigned with a first prevalence that is below a first defined prevalence level; and (iv) within the computer system, signatures of a signature vendor associated with the application were observed with a second prevalence that is below a second defined prevalence level.

There is additionally provided, in accordance with an embodiment of the present invention, a system for detecting a cyber-attack. The system includes an input interface and one or more processors. The input interface is configured to receive events occurring in a computer system. The one or more processors are configured to identify an event occurring in a computer belonging to the computer system, the event including loading of an application to memory together with a Dynamic Link Library (DLL), to apply to the event a filtering criterion, which verifies that (i) the application and the DLL are loaded from a same folder, (ii) the application is signed and verified and (iii) the DLL does not have a valid signature, to apply to the event, responsively to meeting the filtering criterion, a profiling criterion, which verifies that prevalences of defined characteristics of the DLL in the computer system are below defined prevalence levels, and, responsively to meeting the profiling criterion, to decide that the DLL is suspected of being malicious.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for detection of DLL side loading attacks, in accordance with an embodiment of the present invention; and

FIG. 2 is a flow chart that schematically illustrates a method for detecting DLL side loading attacks, in accordance with an embodiment of the present invention.

### DETAILED DESCRIPTION OF EMBODIMENTS

### OVERVIEW

Embodiments of the present invention that are described herein provide methods and systems for automatic detection of DLL side loading attacks. The disclosed techniques achieve an exceptionally high True-Positive (TP) detection probability and very low False-Positive (FP) detection probability. A high TP probability and a low FP probability are both crucial in detection of malicious DLLs, since the use of DLLs is so common and frequent.

In some embodiments, a detection system receives various events occurring in a computer system being protected. For the sake of detecting DLL side loading, the detection system focuses on “load image” events indicating that the operating system of a certain computer has loaded an application together with a DLL. Upon identifying such an event, the detection system evaluates the following criteria: Event filtering criterion: A criterion verifying that (i) the application and the DLL are located in the same folder, (ii) the application is signed and verified, and (iii) the DLL does not have a valid signature (e.g., is unsigned, or has a signature that is invalid). An invalid signature often indicates that the signature is stolen or revoked. Profile filtering criterion: A criterion verifying that one or more defined characteristics of the DLL are uncommon (occur rarely) within the specific computer system (i.e., within the organization domain). The term “uncommon” in this context may mean, for example, that (i) the DLL without a valid signature and (ii) the path to the DLL in normalized form, were each observed only in a small number of computers, and only over a small number of days. Different threshold numbers may be used for the DLL hash and for the path.

In some embodiments, an event that meets both the event filtering criterion and the profile filtering criterion (sometimes referred to jointly as a “base filter”) is considered as suspected of indicating an attack. In such a case, the detection system may initiate a suitable responsive action, e.g., issuing an alert of a certain severity.

In other embodiments, the detection system further refines the analysis of the event by subjecting it to additional tests (referred to as “variations”). Some of the variations depend on a score assigned to the event. The score is typically calculated depending on a set of predefined severity indicators. Various heuristics can be used as severity indicators, e.g., whether the entropy of the DLL is especially high or especially low, whether the folder from which the DLL is loaded has a single-character name, whether the DLL was compiled with a different name and then renamed, etc. Additional severity indicators are suggested and explained herein. In these variations, the detection system typically decides that the event is suspected of indicating a DLL side loading attack if the score matches or exceeds a certain defined threshold.

Additionally or alternatively, one or more of the variations may depend on heuristics relating to the prevalence of legitimate loading events (in which both the application and the DLL are signed and valid) in comparison with suspected loading events (in which the DLL is unsigned). Both local prevalence (within the specific computer system, i.e., within the organization) and global prevalence (across multiple computer systems, e.g., across all organizations protected by the detection system) may be considered, as well as the local prevalence of the signature vendor (“signer”) associated with the DLL. Variations based on these factors are suggested herein, as well.

### SYSTEM DESCRIPTION

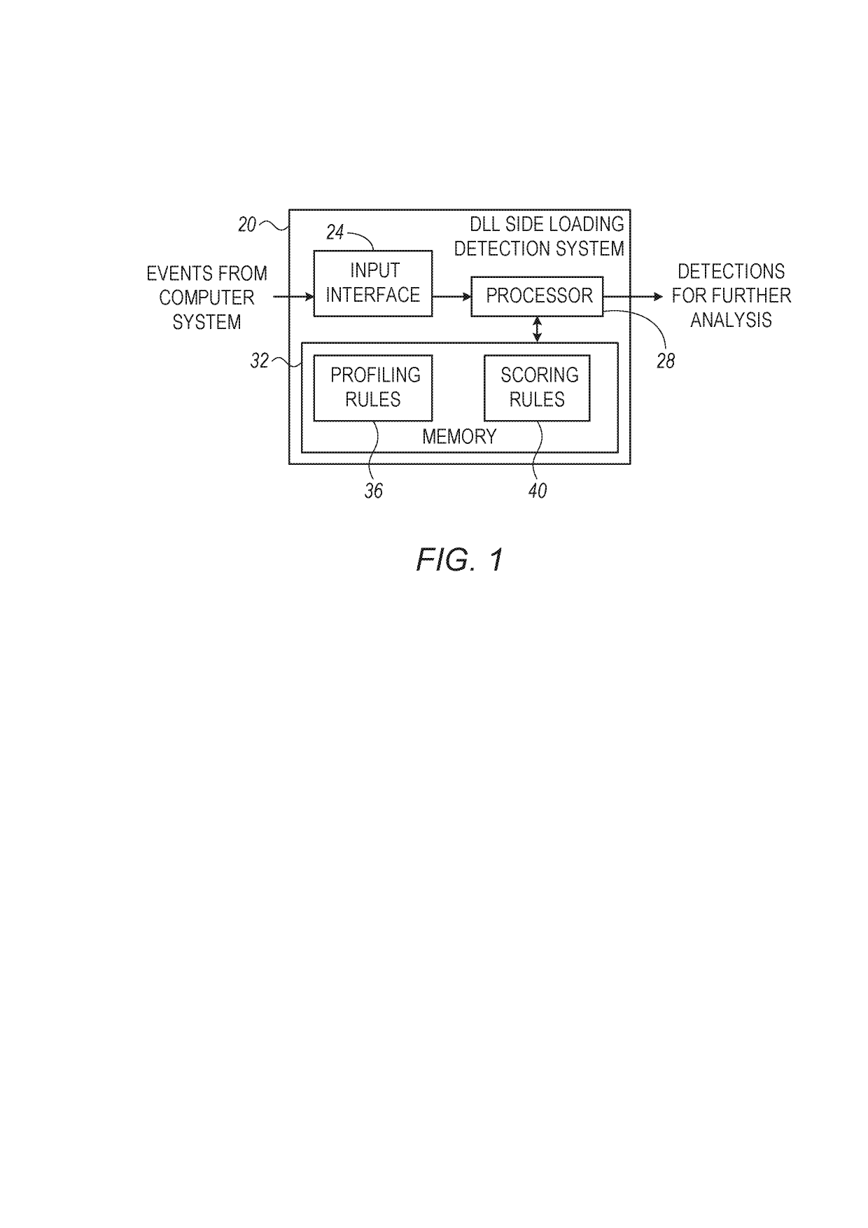

FIG. 1 is a block diagram that schematically illustrates a system 20 for detection of DLL side loading attacks, in accordance with an embodiment of the present invention. System 20 is typically assigned to protect a computer system (not seen in the figure) against malicious attacks, including DLL side loading attacks.

In the embodiment of FIG. 1, system 20 comprises an input interface 24, one or more processors 28 and a memory 32. The description that follows refers to a single processor 28, for clarity.

Input interface 24 receives various events from the computer system being protected. Processor 28 uses the events to automatically detect DLL side loading attacks, using methods that are described below. Upon detecting a suspected DLL side loading attack, processor 28 outputs an indication of the detection (“alert”). The alert typically has a certain severity, e.g., low or medium.

In some embodiments, to detect DLL side loading, processor 28 analyzes the received events using (i) one or more profiling rules 36 and (ii) one or more scoring rules 40. Both types of rules are saved in memory 32. Examples of such rules and their usage are explained in detail below.

The configuration of system 20 shown in FIG. 1 is an example configuration, which is chosen purely for the sake of conceptual clarity. In alternative embodiments, any other suitable configuration can be used. For example, the tasks of processor 28 may be split among multiple processors. Elements that are not necessary for understanding the principles of the present invention have been omitted from the figures for clarity.

The various elements of system 20 may be implemented in hardware, e.g., in one or more Application-Specific Integrated Circuits (ASICs) or FPGAs, in software, or using a combination of hardware and software elements. Memory 32 may comprise any suitable type of memory, e.g., Random-Access Memory (RAM) or disk.

Processors 28 may comprise one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### DLL SIDE LOADING DETECTION METHOD

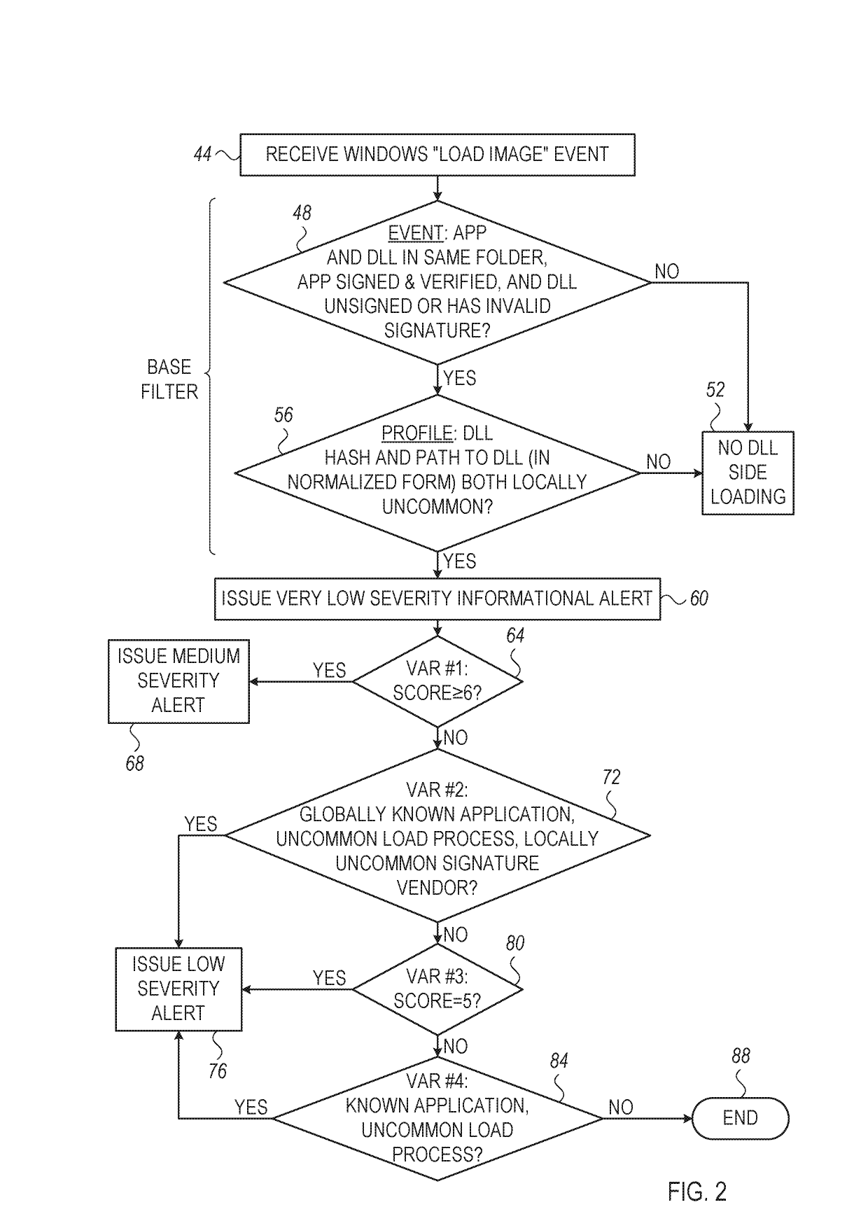

FIG. 2 is a flow chart that schematically illustrates a method for detecting DLL side loading attacks, in accordance with an embodiment of the present invention. In the present example the method is carried out by system 20 of FIG. 1.

The method begins with input interface 24 of system 20 receiving a “load image” event from the computer system being protected, at an event input stage 44. The “load image” event is generated by the operating system of a certain computer in the protected computer system, and indicates that the operating system has loaded an application together with a DLL. The event is forwarded to processor 28.

At an event filtering stage 48, processor 28 evaluates an event filtering criterion with respect to the “load image” event. This criterion filters out “load image” events that are unlikely to be malicious. In the present non-limiting example, the event filtering criterion verifies that (i) the application and the DLL are located (i.e., were loaded from) the same folder, (ii) the loaded application is signed and verified, and (iii) the loaded DLL does not have a valid signature. In the present context, the term “does not have a valid signature” means, for example, that the DLL is not signed, or that it is signed but the signature is invalid for any reason. In alternative embodiments, processor 28 may apply any other suitable event filtering criterion.

If the event filtering criterion is not met, processor 28 considers the event not indicative of a DLL side loading attack, at a benign termination stage 52, and the method terminates.

Otherwise, i.e., if the event filtering criterion is met, processor 28 proceeds to evaluate a profile filtering criterion with respect to the DLL, at a profile filtering stage 56. Generally speaking, the profile filtering criterion verifies that one or more defined characteristics of the DLL are uncommon (occur rarely) within the specific computer system of the organization. In other words, the profile filtering criterion verifies that local prevalences of the defined characteristics of the DLL, in the specific computer system, are below respective defined prevalence levels.

In the present context, the term “a defined characteristic of the DLL” may refer to any characteristic encountered when the specific DLL was loaded within the protected computer system. In some embodiments, the characteristics comprise the hash of the DLL and/or the path of the DLL. In other words, in some embodiments the profile filtering criterion verifies that the hash of the DLL, and the path to the DLL, are both uncommon (occur rarely) within the specific computer system.
1. The path to the DLL was observed to contain DLLs without a valid signature (i) in less than a threshold number of computers in the computer system, and (ii) over less than a threshold number of days.
2. The hash of the DLL was observed (i) in less than a threshold number of computers in the computer system, and (ii) over less than a threshold number of days.

The thresholds listed above may all differ from one another as appropriate.

When counting the occurrences of the path to the DLL for evaluating the above criterion, processor 28 typically considers the normalized form of the path. The normalized form aggregates together different versions of the application and/or different usernames so that all of them (i.e., paths that differ only in the version of the application and/or in username) will be counted together regardless of the differences in folder names. For example, paths such as “C:\Charlie\App12.34” and “C:\Donald\App13.1” are both normalized to “C:\%USER%\App” and counted together.

In alternative embodiments, processor 28 may apply any other suitable profile filtering criterion.

If the profile filtering criterion is not met, processor 28 regards the event not indicative of a DLL side loading attack, at benign termination stage 52, and the method terminates.

As noted above, the event filtering criterion and the profile filtering criterion are referred to jointly as a “base filter”. If the base filter is met (both the event filtering criterion and the profile filtering criterion are met), processor 28 issues an informational alert having a very low severity, at an info alerting stage 60.

Processor 28 then proceeds to perform a sequence of additional tests (referred to as “variations”) in order to assess whether the event of stage 44 above is indicative of a DLL side loading attack or not. A non-limiting example of a sequence of variations is described below. Alternatively, however, any other suitable sequence of variations can be used.

In some embodiments, one or more of the variations depend on a score that is calculated by processor 28 and assigned to the event. To calculate the score. processor 28 typically evaluates one or more predefined severity indicators, and increments the score of the DLL for each severity indicator being met.

In some embodiments, processor 28 divides the severity indicators into high-severity indicators and low-severity indicators. For each high-severity indicator being met, processor 28 increments the score of the DLL by a certain value. For each low-severity indicator being met, processor 28 increments the score of the DLL by a smaller value.

A non-limiting list of high-severity indicators may include the following: The entropy of the DLL is below a defined threshold (e.g., <0.1). The DLL was loaded from a folder defined as highly suspicious (e.g., the folder appears on a list of highly suspicious paths). The DLL is included in a defined list of DLLs known to be malicious (e.g., list of DLLs known to appear in DLL hijacking attacks). In some implementations, the processor also considers the signature vendor (“signer”) associated with the DLL, and/or verifies that the loading event did not occur in the folders in which the app is known to be installed in.

A non-limiting list of low-severity indicators may include the following: The entropy of the DLL is above a defined threshold (e.g., ≥0.8).

The DLL was loaded from a folder defined as suspicious (e.g., the folder appears on a list of suspected paths). The DLL was loaded from a folder having a single-character name (e.g., “C:\David\1\Zoom.dll”). The DLL was compiled with a different internal name or with no visible name (e.g., compiled as “Virus.dll” and then renamed to “Zoom.dll”). The command line of the application has no arguments. The time duration between creation (on disk) and execution of the DLL is below a defined threshold (e.g., below one minute). The application is signed by a security company.

Additionally, or alternatively, processor 28 may use any other suitable severity indicators.

In various embodiments, in accumulating the score, processor 28 may give any suitable relative weights to the high-severity indicators and to the low-severity indicators. In one example embodiment, processor 28 increments the score of the event by five (5) for each high-severity indicator being met, and by one (1) for each low-severity indicator being met.

At a first variation checking stage 64, processor 28 checks whether the score of the event is equal to or greater than six (6). If so, processor 28 issues a medium-severity alert, at a medium-severity termination stage 68, and the method terminates.

Otherwise, processor 28 proceeds to a second variation checking stage 72. The second variation is referred to as “globally known application, uncommon load process, locally uncommon signature vendor”. In this variation, processor 28 checks whether the following conditions are met: The application was observed loading the DLL as signed in more than a first defined number of computer systems. The application was observed loading the DLL as unsigned in less than a second defined number of computer systems. Locally, within the specific computer system, the application was observed loading the DLL as unsigned with a first prevalence that is below a first defined prevalence level. Locally, within the specific computer system, signatures of the signature vendor associated with the application were observed with a second prevalence that is below a second defined prevalence level.

In an example implementation of this variation, processor 28 checks for the following: Globally, the application was observed loading the DLL as signed in more than ten (10) computer systems (“tenants”). Globally, the application was observed loading the DLL as unsigned on less than three (3) computer systems (“tenants”). Within the specific computer system, the application was observed loading the DLL as unsigned on less than three (3) computers. Within the specific computer system, the application was observed loading the DLL as unsigned across less than four (4) days. Within the specific computer system, the signature vendor (signer) of the DLL was observed on less than six (6) computers. Within the specific computer system, the signature vendor of the DLL was observed across less than six (6) days.

If the second variation (“globally known application, uncommon load process, locally uncommon signature vendor”) is met, processor 28 issues a low-severity alert, at a low-severity termination stage 76, and the method terminates.

Otherwise, processor 28 proceeds to a third variation checking stage 80. In the third variation, processor 28 checks whether the score of the event is equal to five (5). If so, processor 28 issues a low-severity alert at low-severity termination stage 76, and the method terminates.

Otherwise, processor 28 proceeds to a fourth variation checking stage 84.

The fourth variation is referred to as “known application, uncommon load process”. In this variation, processor 28 checks whether the following conditions are met locally, within the specific computer system being protected: The application was observed loading the DLL as signed with a first local prevalence that is above a first defined prevalence level. The application was observed loading the DLL as unsigned with a second local prevalence that is below a second defined prevalence level.

In an example implementation of this variation, processor 28 checks for the following:

The application (in this embodiment defined as a combination of (i) normalized process name and (ii) signature vendor) was observed loading the DLL as signed on more than five (5) computers in the computer system. The application was observed loading the DLL as unsigned on less than six (6) computers in the computer system. Within the computer system, the application was observed loading the DLL as unsigned across less than three (3) days. The DLL loaded in the present event is unsigned.

If the fourth variation (“known application, uncommon load process”) is met, processor 28 issues a low-severity alert at low-severity termination stage 76, and the method terminates. Otherwise, processor 28 does not issue an additional alert (beyond the informational alert already issued at stage 60 above), and the method terminates at a termination stage 88.

The method flow of FIG. 2 is an example flow that is chosen purely for the sake of conceptual clarity. In alternative embodiments, any other suitable flow can be used. For example, in some embodiments the entire scoring and variation checking process can be omitted. In these embodiments, processor 28 would decide that a DLL is suspected of being malicious if the event filtering criterion (stage 48) and the profile filtering criterion (stage 56) are met, without additional requirements. The criteria, the order of evaluation of the criteria and the numerical values given above are depicted purely by way of example. Any other suitable criteria, orders and parameters can be used in alternative embodiments.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for detecting an attempt to side-load a malicious Dynamic Link Library (DLL), the method comprising:
identifying a load image event in a computer system, the load image event indicating that an operating system has loaded an application together with a DLL;
applying to the load image event an event filtering criterion that assesses signatures of the application and the DLL;
applying to the load image event a profile filtering criterion that assesses prevalence of characteristics of the DLL within the computer system; and
responsively to meeting both the event filtering criterion and the profile filtering criterion, determining that the load image event is suspected of indicating a DLL side-loading attack.

2. The method according to claim 1, wherein the event filtering criterion verifies that the application is signed and verified and the DLL does not have a valid signature.

3. The method according to claim 1, wherein the event filtering criterion verifies that the application and the DLL are loaded from the same folder.

4. The method according to claim 1, wherein the profile filtering criterion verifies that the characteristics of the DLL are uncommon within the computer system.

5. The method according to claim 1, wherein the profile filtering criterion verifies that the DLL was observed in the computer system on less than a defined number of computers and during less than a defined number of days.

6. The method according to claim 1, wherein the profile filtering criterion verifies that a path to the DLL was observed, in the computer system, to contain DLLs having no valid signatures on less than a defined number of computers and during less than a defined number of days.

7. The method according to claim 1, further comprising initiating a responsive action upon determining that the load image event is suspected of indicating a DLL side-loading attack.

8. A system for detecting an attempt to side-load a malicious Dynamic Link Library (DLL), the system comprising:
an input interface configured to receive load image events from a computer system; and
one or more processors configured to:
identify a load image event indicating that an operating system has loaded an application together with a DLL;
apply to the load image event an event filtering criterion that assesses signatures of the application and the DLL;
apply to the load image event a profile filtering criterion that assesses prevalence of characteristics of the DLL within the computer system; and
responsively to meeting both the event filtering criterion and the profile filtering criterion, determine that the load image event is suspected of indicating a DLL side-loading attack.

9. The system according to claim 8, wherein the event filtering criterion verifies that the application is signed and verified and the DLL does not have a valid signature.

10. The system according to claim 8, wherein the event filtering criterion verifies that the application and the DLL are loaded from the same folder.

11. The system according to claim 8, wherein the profile filtering criterion verifies that the characteristics of the DLL are uncommon within the computer system.

12. The system according to claim 8, wherein the profile filtering criterion verifies that the DLL was observed in the computer system on less than a defined number of computers and during less than a defined number of days.

13. The system according to claim 8, wherein the profile filtering criterion verifies that a path to the DLL was observed, in the computer system, to contain DLLs having no valid signatures on less than a defined number of computers and during less than a defined number of days.

14. The system according to claim 8, wherein the one or more processors are further configured to initiate a responsive action upon determining that the load image event is suspected of indicating a DLL side-loading attack.

15. A non-transitory computer-readable medium storing instructions that, when executed by one or more processors, cause the one or more processors to perform a method for detecting an attempt to side-load a malicious Dynamic Link Library (DLL), the method comprising:
identifying a load image event in a computer system, the load image event indicating that an operating system has loaded an application together with a DLL;
applying to the load image event an event filtering criterion that assesses signatures of the application and the DLL;
applying to the load image event a profile filtering criterion that assesses prevalence of characteristics of the DLL within the computer system; and
responsively to meeting both the event filtering criterion and the profile filtering criterion, determining that the load image event is suspected of indicating a DLL side-loading attack.

16. The non-transitory computer-readable medium according to claim 15, wherein the event filtering criterion verifies that the application is signed and verified and the DLL does not have a valid signature.

17. The non-transitory computer-readable medium according to claim 15, wherein the event filtering criterion verifies that the application and the DLL are loaded from the same folder.

18. The non-transitory computer-readable medium according to claim 15, wherein the profile filtering criterion verifies that the characteristics of the DLL are uncommon within the computer system.

19. The non-transitory computer-readable medium according to claim 15, wherein the profile filtering criterion verifies that the DLL was observed in the computer system on less than a defined number of computers and during less than a defined number of days.

20. The non-transitory computer-readable medium according to claim 15, wherein the profile filtering criterion verifies that a path to the DLL was observed, in the computer system, to contain DLLs having no valid signatures on less than a defined number of computers and during less than a defined number of days.
